(19) United States
(12) Patent Application Publication
(10) Pub. No.: US 2026/0223060 A1
(43) Pub. Date: Jul. 30, 2026

(54) POWER SAVINGS FOR POSITIONING AND LOCATION SERVICES

(71) Applicant: ResMed Inc., San Diego, CA (US)

(72) Inventors: Snehasish KAR, Guwahati Assam (IN); Naga Manoj Kumar Aguduri, San Diego, CA (US)

(21) Appl. No.: 19/459,484

(22) Filed: Jan. 26, 2026

Related U.S. Application Data
(60) Provisional application No. 63/751,613, filed on Jan. 30, 2025.

(51) Int. Cl. H04W 64/00; H04L 27/26

(52) U.S. Cl. CPC H04W 64/00; H04L 27/261

(57) ABSTRACT

Certain aspects of the present disclosure provide techniques for power saving in positioning and location services for reduced capability user equipment. A method for wireless communications at a base station (BS) includes sending a radio resource control (RRC) configuration message, to a user equipment (UE), that configures one or more reference signals for positioning and location services. The method includes performing positioning and location measurements of the one or more reference signals from the UE based on the configuration.

### CROSS-REFERENCE TO RELATED APPLICATIONS

This application claims priority to U.S. Provisional Patent Application No. 63/751,613, filed January 30, 2025, and entitled “POWER SAVING METHOD AND APPARATUS FOR POSITIONING AND LOCATION SERVICES,” which is assigned to the assignee hereof and hereby expressly incorporated by reference herein.

### BACKGROUND

### Field of the Disclosure

Aspects of the present disclosure relate to wireless communications, and more particularly, to systems, devices, methods, and techniques for power savings for positioning and location services.

### Description of Related Art

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

A communication system may include a wireless communication network (such as a radio access network (RAN)) that supports communication between wireless communication devices such as network entities (such as base stations (BSs)), client devices (such as one or more user equipments (UEs)), and others. Such devices may communicate with one another using a variety of protocols (e.g., radio access technologies (RATs) that have been adopted in various telecommunication standards, which define common protocols that enable different wireless communication devices to communicate on a local, municipal, national, regional, or global level, including those of cellular-based systems such as fourth generation (4G) systems (e.g., Long Term Evolution (LTE) systems), fifth generation (5G) systems (such as 5G New Radio (5G-NR) systems), and sixth generation (6G) systems that are part of a continuous mobile broadband evolution promulgated by the Third Generation Partnership Project (3GPP). A wireless communication network may support communication by implementing system resources (such as frequency resources, time resources, spatial resources) in accordance with a wireless communication protocol.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

One aspect provides a method for wireless communication by a BS. The method includes sending a radio resource control (RRC) configuration message, to a UE, that configures one or more reference signals for positioning and location services. The method includes performing positioning and location measurements of the one or more reference signals from the UE based on the configuration.

Another aspect provides a method for wireless communication at a location management function (LMF). The method includes transmitting a positioning and location services reference signal configuration to one or more BSs. The method includes receiving, from the one or more BSs in response to the positioning and location services reference signal configuration, positioning and location measurements of one or more reference signals for positioning and location services associated with one or more UEs. The method includes determining positioning and location information of the one or more UEs based on the positioning and location measurements.

Another aspect provides a method for wireless communication at a UE. The method includes receiving a RRC configuration message, from a BS, that configures one or more reference signals for positioning and location services. The method includes transmitting the one or more reference signals to the BS based on the configuration.

According to an aspect of the present disclosure, a method is provided that includes creating a message element for a configuration message (e.g., network configuration message) by a BS. The method includes inserting the message element into the configuration message. The configuration message may be a RRC reconfiguration (RRC_Reconfiguration) message. The message element may be a preconfigured reference signal for location events (e.g., one or more location events). The method includes sending the configuration message to a user equipment. In one or more aspects, the method can include sending the configuration message to a device where the preconfigured reference signal is a sounding reference signal (SRS) and the message element is a SRS request location event (SRS-Request_Location_event). The SRS-Request_Location_event may further include a SRS for location event request (srs-LocationEventRequest) and the SRS-Request_Location_event is for the location events triggering. The SRS-Request_Location_event may include at least one of: periodic SRS resource signaling (Periodic SRS), scheduled time, affected cell identifier (ID), and/or periodicity. The location events may be determined by one or more location measurement functions (LMFs). The method may further include sending the RRC_Reconfiguration message from a Next Generation Node B (gNB) or a 5G BS to the device, where the RRC_Reconfiguration contains at least one of: a periodic resource allocation, an aperiodic resource allocation, and/or a semi-persistent resource allocation. The device may activate a preconfigured SRS with a new cause code requesting the BS to allocate resources accordingly. In one or more aspects, the BS can collect and transmit UE location information from the UE and transmit the UE location information to the one or more LMFs. The one or more LMFs may receive the UE location information from the BS.

According to another aspect of the present disclosure, an apparatus is provided. The apparatus can include at least one processor and at least one memory including computer program code. The at least one memory and the computer program code may be configured to, with the at least one processor, cause the apparatus to create a message element for a configuration message (e.g., a network configuration message) by a BS. The at least one memory and the computer program code may be configured to, with the at least one processor, cause the apparatus to insert the message element into the configuration message. The configuration message may be a RRC_Reconfiguration message. The message element may be a preconfigured reference signal for location events (e.g., one or more location events). The at least one memory and the computer program code may be configured to, with the at least one processor, cause the apparatus to send the configuration message to a user equipment. The at least one memory and the computer program code may be further configured to, with the at least one processor, cause the apparatus to send the configuration message to a device. The preconfigured reference signal may be a SRS and the message element may be a SRS-Request_Location_event. The SRS-Request_Location_event may further include a srs-LocationEventRequest. The SRS-Request_Location_event may be for the location events triggering. The SRS-Request_Location_event may include at least one of: periodic SRS, a scheduled time, an affected cell ID, and/or a periodicity. The location events may be determined by one or more LMFs. The at least one memory and the computer program code may be configured to, with the at least one processor, cause the apparatus to send the RRC_Reconfiguration message from a BS to the device. The device may activate the preconfigured SRS with a new cause code requesting the BS to allocate resources accordingly. The BS may collect UE location information from the UE and may transmit the UE location information to the one or more LMFs. The one or more LMFs may receive the UE location information from the BS.

According yet another aspect of the present disclosure, a method is provided. The method includes receiving a configuration message (e.g., a network configuration message) that contains at least a message element by a UE. The configuration message may be a RRC_Reconfiguration message. The message element may be a preconfigured SRS for one or more location events. The message element may include one or more information elements (IEs). The method may include sending a location information based on the one or more IEs. In one or more aspects, the location event includes at least one indication srs-LocationEventRequest, indicating location event triggering. The location event triggering may contain at least one of a periodic SRS, a scheduled time, an affected cell ID, and/or a periodicity. The method may further include sending location information based on the location event trigger to one or more BSs. The one or more BSs may send the user location information to one of more LMFs.

According yet another aspect of the present disclosures, an apparatus is provided. The apparatus may include at least one processor and at least one memory including computer program code. The at least one memory and the computer program code may be configured to, with the at least one processor, cause the apparatus to receive a configuration message (e.g., a network configuration message) that contains at least a message element by a UE. The configuration message may be a RRC_Reconfiguration message. The message element may be a preconfigured SRS for one or more location events (e.g., one or more location events). The message element may include one or more IEs. The at least one memory and the computer program code may be configured to, with the at least one processor, cause the apparatus to send a location information based on the one or more IEs. The SRS location event may include at least one indication srs-LocationEventRequest indicating a location event triggering. The location event triggering may contain at least one of: a periodic SRS, a scheduled time, an affected cell ID, and/or a periodicity. The at least one memory and the computer program code may be configured to, with the at least one processor, cause the apparatus to send location information based on the position location event trigger to one or more BSs. The one or more BSs may send the user location information to one of more LMFs.

Other aspects provide: an apparatus operable, configured, or otherwise adapted to perform any one or more of the aforementioned methods and/or those described elsewhere herein; a non-transitory, computer-readable media comprising instructions that, when executed by one or more processors of an apparatus, cause the apparatus to perform the aforementioned methods as well as those described elsewhere herein; a computer program product embodied on a computer-readable storage medium comprising code for performing the aforementioned methods as well as those described elsewhere herein; and/or an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example positioning and location services system within a wireless communications network.

FIG. 2 depicts aspects of an example UE.

FIG. 3 depicts aspects of an example BS.

FIG. 4 depicts a call flow diagram illustrating example operations for communications in a network between a UE, a BS, and an LMF.

FIG. 5 depicts a method for wireless communications by a UE.

FIG. 6 depicts a method for wireless communications by a BS.

FIG. 7 depicts a method for wireless communications by a LMF.

### DETAILED DESCRIPTION

Aspects of the present disclosure provide apparatuses, methods, processing systems, and computer-readable mediums for power savings for positioning and location services. Some aspects of the present application relate generally to power savings for reduced capability (RedCap) UE when retrieving location information in cellular system.

In order to provide better positioning estimate in 5G, new reference signals were added to the NR specifications—the NR positioning reference signal (NR PRS) for the downlink-based positioning and the sounding reference signal (SRS) for uplink-based positioning. Since positioning involves measurements from multiple receiving BSs, the reference signal can have enough range to reach not only the serving BS to which the UE is connected, but also the neighbouring BSs involved in the positioning process. To minimize interference, the UE can be configured with different SRS instances, each with independent power control loops to allow SRS pointed at neighbour cells to have better hearability while keeping the interference low in the serving cell.

3GPP, Release 17, introduces enhancements that enable a new class of devices, such as Internet-of-Thing (IoT) devices (e.g., wearables, wireless sensors, surveillance equipment, etc.) with reduced capabilities, to run on 5G networks (e.g., to connect to the Internet via 5G networks). This new class of devices with reduced

capabilities is referred to as RedCap devices. RedCap devices are less complex, less costly, and more power efficient than conventional 5G devices like smartphones. However, RedCap devices do not require the full capabilities and performance enabled by the 5G NR standard. Thus, RedCap devices can benefit from the scale of 5G deployments but leverage fewer capabilities for an optimal balance of features versus cost and power consumption.

5G RedCap addresses applications for simpler and lower-cost IoT devices such as sensors and actuators that send small packets of information continuously and require a long battery life. Such applications do not fit neatly into any initial use cases defined by the 5G NR standard. Release 17 specifies three RedCap use cases include wearables such as smart watches, wearable medical devices, and low-end AR/VR glasses, video surveillance, industrial sensors, smart grids, and so on. Each RedCap use case has its own requirements for maximum data rate, end-to-end latency, and service availability.

Each addressable RedCap use case has its own set of requirements which, compared to regular 5G NR devices, is less demanding in terms of data rates and latency, yet more stringent when it comes to device cost/complexity and power consumption. While the battery life for RedCap use cases are relatively relaxed compared to those of massive machine type communications (mMTC) use cases, the power saving is still a concern.

The present disclosure addresses these challenges by providing a method and apparatus for preconfiguring SRS for location events. A BS may create a message element for a configuration message, such as a RRC_Reconfiguration message, where the message element may be a preconfigured reference signal for location events. The BS may insert the message element, which may be a SRS-Request_Location_event element, into the RRC_Reconfiguration message and send the RRC_Reconfiguration message to the UE. The SRS-Request_Location_event may include a srs-LocationEventRequest that triggers location events and may contain parameters such as periodic SRS resource signaling, scheduled time, affected cell ID, and periodicity. The location events may be determined by one or more LMFs. The RRC_Reconfiguration message may contain resource allocations that are periodic, aperiodic, or semi-persistent. The BS may collect UE location information when the SRS signals are received and may transmit the information to the LMFs, enabling location information to be obtained without directly contacting the device.

The disclosed techniques may provide significant power savings for RedCap devices and IoT devices by eliminating the need to wake up a device when a location information request is received. By preconfiguring SRS resources and enabling event-triggered location reporting, the UE can transmit location information according to predefined parameters without requiring additional signaling from the network. The use of small data transmission further reduces energy consumption. Additionally, by having the BS collect and store location information from received SRS signals, the network can provide location information to LMFs without having to contact the UE directly, thereby preserving battery life while maintaining positioning service capabilities. This approach enables RedCap devices to fulfill positioning requirements while achieving extended battery life through reduced traffic and signal requirements.

### Example Positioning and Location Services in a Wireless Communications Network

The techniques and methods described herein may be used for various wireless communications networks. While aspects may be described herein using terminology commonly associated with 4G, 5G, and/or 6G wireless technologies, aspects of the present disclosure may likewise be applicable to other communications systems and standards not explicitly mentioned herein.

A communication system may include a RAN that supports wireless communication. Communication in a RAN may be performed in accordance with one or more RATs, including 4G, 5G, or 6G, among others, including technologies not explicitly mentioned herein. A RAT may employ access technologies (such as multiplexing technologies) including code division multiple access (CDMA), time division multiple access (TDMA), frequency division multiple access (FDMA), orthogonal FDMA (OFDMA), single-carrier FDMA (SC-FDMA), time division synchronous CDMA (TD-SCDMA), or discrete Fourier transform spread OFDM (DFT-S-OFDM), among others.

A RAT may support one or more service types, including machine type communication (MTC), massive MTC (mMTC), Internet of Things (IoT), narrowband IoT (NB-IoT), reduced capability (RedCap), enhanced mobile broadband (eMBB), ultra-reliable low-latency communication (URLLC), or public safety, among others. To support these and other target verticals, a communication system (such as a RAN) may be designed to implement one or more of a modularized functional infrastructure, a disaggregated and service-based network architecture, network function virtualization, network slicing, multi-access edge computing, spatial processing or multipath techniques, IoT or RedCap device connectivity and management, industrial connectivity, licensed and unlicensed spectrum access, sidelink or other device-to-device (D2D) direct communication (such as vehicle-to-everything (V2X)), frequency spectrum expansion, overlapping spectrum use, small cell deployments, non-terrestrial network (NTN) deployments, device aggregation, advanced duplex communication (such as sub-band full-duplex (SBFD)), multiple-subscriber implementations, high-precision positioning, radio frequency (RF) sensing, network energy savings (NES), low-power signaling and radios, or artificial intelligence or machine learning (AI/ML), among other examples.

The foregoing and other technological improvements may support use cases such as voice calls, messaging, data transfer, streaming, wireless data centers, extended reality (XR) and metaverse applications, vehicle connectivity, holographic and mixed reality communication, autonomous and collaborative robots, sensing networks, gesture monitoring, human-brain interfacing, digital twin applications, asset management, and universal coverage using non-terrestrial or aerial platforms, among other examples. As the demand for connectivity continues to increase, further improvements may be implemented, and other RATs, including 6G and beyond, may be introduced to enable new applications and use cases. The systems, methods, and devices described herein may enable one or more of the foregoing technologies or new technologies or support one or more of the foregoing use cases or new use cases.

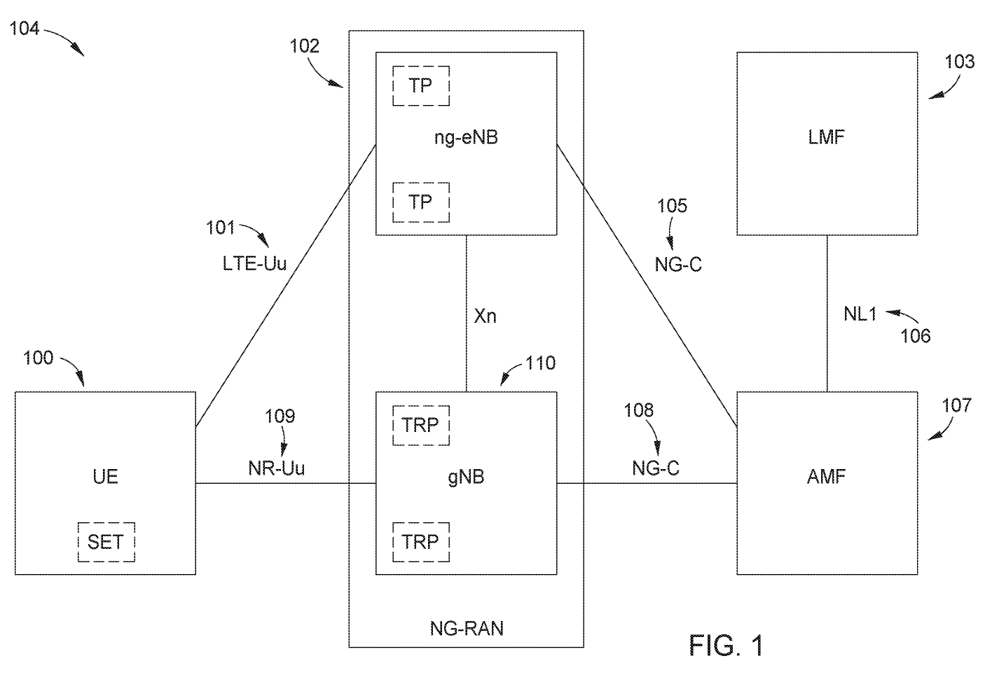

FIG. 1 depicts an example positioning and location services system 104 within a wireless communications network for providing positioning and location services to a UE 100. In some aspects, example positioning and location services system 104 may include aspects of a 3GPP system for positioning of a UE with gNB or LTE eNB access as defined by 3GPP TS 38.305 v18.4.0 and earlier and 3GPP TS 38.305 v17.7.0 and earlier, and earlier releases, where the entirety of 3GPP TS 38.305 v18.4.0 and earlier and 3GPP TS 38.305 v17.7.0 and earlier, and earlier releases are incorporated herein by reference.

A network entity (alternatively, network elements or network nodes). is generally a communications device and/or a communications function performed by a communications device (e.g., a UE, a BS, a component of a BS, a server, etc.). For example, various functions of a network as well as various devices associated with and interacting with a network may be considered network entities. Further, a wireless communications network may includes terrestrial aspects, such as ground-based network entities, and non-terrestrial aspects, such as a satellite and aircraft, which may include network entities on-board (e.g., one or more BSs) capable of communicating with other network elements (e.g., terrestrial BSs) and UEs.

A wireless communications network may include network entities, UEs, and one or more core networks, such as an evolved packet core (EPC) and a core network (e.g., such as a 5G Core (5GC) network or 6G core (6GC) network, which interoperate to provide communications services over various communications links, including wired and wireless links. The core network may include various functional components, including: an access and mobility management function (AMF), a session management function (SMF), and a user plane function (UPF).

Different network entities within the wireless communications network may also be configured to support different RATs, such as 4G, 5G, and/or 6G. For example, network entities configured for 4G LTE (collectively referred to as Evolved Universal Mobile Telecommunications System (UMTS) Terrestrial RAN (E-UTRAN)) may interface with the EPC through first backhaul links (e.g., an S1 interface). Network entities 102 interface with the core network through second backhaul links. Network entities may communicate directly or indirectly (e.g., through the EPC or core network) with each other over third backhaul links (e.g., X2 interface), which may be wired or wireless.

The UE 100 may communicate with a next generation RAN (NG-RAN) including a BS. A BS may be referred to as a NodeB (NB), an evolved NB (eNB), a next-generation NB or giga-NB (either of which may be referred to as a gNB), a 5G NB, a 6G NB, a Home NB, a Home eNB, an access point (AP), a base transceiver station, radio BS, radio transceiver, transceiver function, a transmission reception point (TRP), or other suitable terminology. As shown in FIG. 1, the UE 100 may communicate with next generation eNodeB 102 (ng-eNB 102) and a gNB 110.

The wireless communications network may subdivide the electromagnetic spectrum into various classes, licensed or unlicensed operating bands, frequency ranges, component carriers, or channels, that define associated frequencies available for communications. In some aspects, the subdivision is provided based on wavelength and frequency, where frequency may also be referred to as a carrier, a subcarrier, a frequency channel, a tone, or a subband.

The ng-eNB 102 or gNB 110 and the UE 100 may establish a communication link or beam pair, and otherwise increase reliability, throughput, signal strength, or other signal properties for MIMO communications, by performing beam management operations, such as an initial beam acquisition operation, a beam refinement operation, or a beam recovery operation. For example, an initial beam acquisition operation may involve the ng-eNB 102 or gNB 110 transmitting signals (for example, SSBs or other signals) via respective beams and the UE 100 receiving and measuring the signal(s) via respective beams of multiple beams to identify a best beam (or beam pair) for communication between the UE 100 and the ng-eNB 102 or gNB 110. A beam refinement operation may involve a first device (for example, the UE 100 or the ng-eNB 102 or gNB 110) transmitting signal(s) via a subset of beams (for example, identified based on, or otherwise associated with, measurements reported as part of one or more other beam management operations). A second device (for example, the ng-eNB 102 or gNB 110 or the UE 100) may receive the signal(s) via a single beam (for example, to identify the best beam for communication from the subset of beams). The beam(s) may be identified or defined via one or more spatial parameters, such as a transmission configuration indicator (TCI) state or a quasi co-location (QCL) parameter, among other examples.

The UE 100 may communicate with the ng-eNB 102 via an LTE-Uu interface 101. The LTE-Uu interface 101 may be a radio interface that carries and handles data traffic and signaling messages between the UE 100 and the ng-eNB 102. The ng-eNB 102 may include transmission points for handling data traffic and signaling messages between the UE 100 and the network.

The UE 100 may communicate with the gNB 110 via an NR-Uu interface 109. The NR-Uu interface 109 may be a radio interface similar to the LTE-Uu interface 101 that carries and handles data traffic and signaling messages between the UE 100 and the gNB 110. The data traffic may include user packet data exchanged between the UE 100 and the gNB 110. The signaling messages may include, for example, a paging message sent from the gNB 110 to the UE 100, or a paging response message from the UE 100 to the gNB 110. The BS 110 may include TRPs. In some examples, the wireless communication network may implement multi-TRP (mTRP) operation (including redundant transmission or reception on multiple TRPs) or non-coherent joint transmission (NC-JT).

The ng-eNB 102 and the gNB 110 may be connected to each other via an Xn interface, enabling communication between these network entities.

The wireless communication system may implement a service-based architecture that provides a modular framework in which control plane functionality and common data repositories may be delivered through a set of interconnected network functions (NFs) that may access services of other NFs.

With continued reference to FIG. 1, the positioning and location services system 104 may include a LMF 103 that processes location services requests and computes the position of the UE 100. The LMF 103 may receive measurements and assistance information from the gNB 110 and the UE 100 via an AMF 107.

The AMF 107 may be in communication with unified data management (UDM). AMF 107 may be a control node that processes signaling between UE 100 and the core network. AMF 107 may provide, for example, quality of service (QoS) flow and session management. The AMF 107 may receive a request for one or more location services associated with a particular target UE from another entity, or the AMF 107 may decide to initiate some location service on behalf of a particular target UE. The AMF 107 may then send a location services request to the LMF 103.

The LMF 103 may process the location services request, which may include transferring assistance data to the target UE 100 to assist with UE-based and/or UE-assisted positioning, and/or may include positioning of the target UE 100. The LMF 103 may then return a result of the location service back to the AMF 107.

The ng-eNB 102 may connect to the AMF 107 via a next generation control (NG-C) interface 105, which may serve as a control plane interface carrying control messages between the ng-eNB 102 and the AMF 107. Similarly, the gNB 110 may connect to the AMF 107 via an NG-C interface 108. The control messages may include, for example, an event configuration message, a SRS-LocationEventRequest message, and/or a corresponding response message. The LMF 103 may connect to the AMF 107 through an NL1 interface 106 for positioning procedures related to the UE 100, the gNB 110, and the ng-eNB 102. The gNB 110, the ng-eNB 102, the AMF 107, and the LMF 103 may be network entities.

In some aspects, the LMF 103 may use a NR positioning protocol A (NRPPa) protocol to carry positioning information between the gNB 110 and the LMF 103 over the NG-C interface 108. The LMF 103 may configure the UE 100 using a LTE positioning protocol (LPP) via the AMF 107. The gNB 110 may configure the UE 100 using a RRC protocol over the LTE-Uu interface 101 and the NR-Uu interface 109.

RAT dependent positioning technologies may use the cellular network radio signal to obtain positioning measurements. These measurements may be based on the timing of the signal, on the power of the signal, or based on the angle of arrival (AoA) or angle of departure (AoD) of the signal. Timing-based positioning methods may include downlink time difference of arrival (DL-TDOA) or multi-round trip time (Multi-RTT). Power-based positioning methods may include enhanced cell ID (ECID). Angle-based positioning methods may include downlink AoD (DL-AoD). When the LMF 103 determines a positioning method for the UE 100 that requires gNB 110 measurements, the LMF 103 may interact with the gNB 110 to support the positioning method.

### Example User Equipment

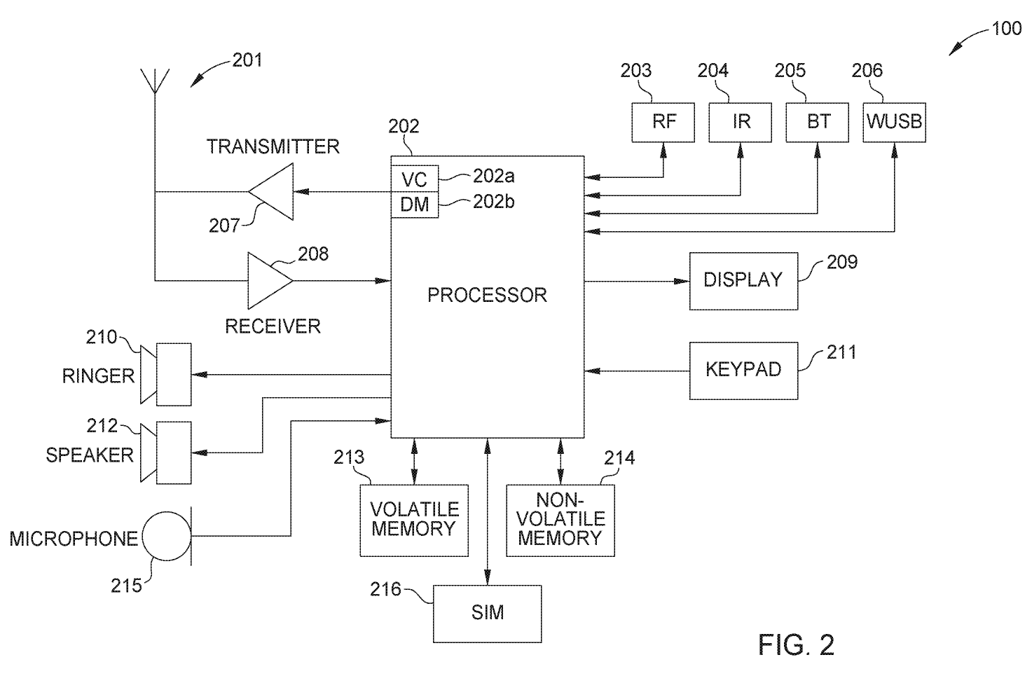

FIG. 2 depicts aspects of an example UE 100.

UE 100 may be capable of transmitting and receiving wireless communications in the form of, for example, wireless packets. For example, UE 100 may be configurable or configured to transmit and receive signals and communications conforming to one or more 3GPP specifications including those for 5G NR or 6G, among others. Additionally, or alternatively, UE 100 may be configurable or configured to transmit and receive signals and communications conforming to one or more of the Institute of Electrical and Electronics Engineers (IEEE) 802.11 family of wireless communication protocol standards, among others.

In some aspects, the UE 100 may be a mobile terminal or RedCap device designed for IoT applications with reduced complexity, lower cost, and improved power efficiency compared to conventional 5G devices. The UE 100 may be one of various IoT devices including wearables such as smart watches, wearable medical devices, low-end AR/VR glasses, video surveillance equipment, industrial sensors, and smart grid devices.

While in some examples, the UE 100 is described as a RedCap device, the UE 100 may be other types of electronic devices, such as a mobile telephone, a smartphone, a mobile computer, a tablet computer, a phablet device, a portable digital assistant (PDA), a pager, a laptop computer, a desktop computer, a gaming device, a television, a router, a home gateway, or other types of electronic system.

As shown in FIG. 2, the UE 100 may include at least one antenna 201 in communication with a transmitter 207 and a receiver 208. In some aspects, transmit and receive antennas may be separate. The UE 100 may also include a processor 202 configured to provide signals to and receive signals from the transmitter 207 and the receiver 208, respectively, and to control the functioning of the UE 100. The processor 202 may be configured to control the functioning of the transmitter 207 and the receiver 208 by effecting control signaling via electrical leads to the transmitter 207 and the receiver 208. The processor 202 may be configured to control other elements of the UE 100 by effecting control signaling via electrical leads connecting the processor 202 to the other elements.

In some aspects, the UE 100 may support Narrow-band Advanced Mobile Phone System (NAMPS), Total Access Communication System (TACS), dual mode, and/or higher modes, such as for example, digital/analog phones and TDMA/CDMA/analog phones.

With continued reference to FIG. 2, the processor 202 may include a voice coder 202a and a data modem 202b. The processor 202 may be embodied as various components including circuitry, at least one processing core, one or more microprocessors with accompanying digital signal processors (DSPs), one or more processors without an accompanying DSP, one or more coprocessors, one or more multi-core processors, one or more controllers, processing circuitry, one or more computers, various other processing elements including integrated circuits such as an application specific integrated circuit (ASIC) or a field programmable gate array (FPGA), other software and/or hardware elements, and/or some combination thereof. A processor including exactly one processing core may be referred to as a single-core processor, while a processor including more than one processing core may be referred to as a multi-core processor. Although illustrated in FIG. 2 as a single processor, in some aspects the processor 202 may include a plurality of processors or processing cores. The processor 202 may be configured to perform physical (PHY) layer operations and medium access control (MAC) layer operations, and, in some instances, upper layer operations, associated with transmitting and receiving wireless communications.

Signals sent and received by the processor 202 may include signaling information in accordance with an air interface standard of an applicable cellular system, and/or any number of different wireline or wireless networking techniques, including but not limited to Wi-Fi, wireless local access network (WLAN) techniques such as IEEE 802.11, IEEE 802.16, and/or the like. The UE 100 may be capable of operating with one or more air interface standards, communication protocols, modulation types, access types, and/or the like. The UE 100 may be capable of operating in accordance with various 1G, 2G, 2.5G, 3G, 4G, 5G, 6G, Internet Protocol Multimedia Subsystem (IMS) communication protocols, session initiation protocol (SIP), and/or the like. The UE 100 may be capable of operating in accordance with 2G wireless communication protocols IS-136, TDMA, Global System for Mobile communications (GSM), IS-95, CDMA, and/or the like. The UE 100 may be capable of operating in accordance with 2.5G wireless communication protocols General Packet Radio Service (GPRS), Enhanced Data GSM Environment (EDGE), and/or the like. The UE 100 may be capable of operating in accordance with 3G wireless communication protocols such as UMTS, CDMA 2000 (CDMA2000), Wideband CDMA (WCDMA), Time Division-Synchronous CDMA (TD-SCDMA), LTE or Evolved UTRAN (E-UTRAN), and/or the like. The UE 100 may be capable of operating in accordance with 4G wireless communication protocols such as LTE Advanced and/or the like. The UE 100 may be capable of operating according to Wi-Fi or Worldwide Interoperability for Microwave Access (WiMAX) protocols. The UE 100 may be capable of operating in accordance with 5G NR standards. The UE 100 may be capable of operating in accordance with 6G NR standards or later.

As further shown in FIG. 2, the UE 100 may include one or more components and/or mechanisms for sharing and/or obtaining data. The UE 100 may include a short-range radio frequency (RF) transceiver 203 so data may be shared with and/or obtained from electronic devices in accordance with RF techniques. The UE 100 may include other short-range transceivers, such as an infrared (IR) transceiver 204, a Bluetooth^{TM} transceiver 205 operating using Bluetooth^{TM} wireless technology developed by the Bluetooth Special Interest Group, and a wireless universal serial bus (USB) transceiver 206. The Bluetooth^{TM} transceiver 205 may be capable of operating according to low power or ultra-low power Bluetooth^{TM} technology, for example, Bluetooth^{TM} low energy radio standards. The UE 100 and, in particular, the short-range transceivers may be capable of transmitting data to and/or receiving data from electronic devices within a proximity of the UE 100, such as within 10 meters. The UE 100 may be capable of transmitting and/or receiving data from electronic devices according to various wireless networking techniques, including 6LoWpan, Wi-Fi, Wi-Fi low power, WLAN techniques such as IEEE 802.11 techniques, IEEE 802.15 techniques, IEEE 802.16 techniques, and/or the like.

With continued reference to FIG. 2, the UE 100 may include a user interface including, for example, a speaker 212, a ringer 210, a microphone 215, a display 209, a user input interface, and/or the like, which may be operationally coupled to the processor 202. The UE 100 may include a stereo microphone. The UE 100 may include at least one camera. The processor 202 may include user interface circuitry configured to control at least some functions of one or more elements of the user interface, such as the speaker 212, the ringer 210, the microphone 215, the display 209, and/or the like. The processor 202 and/or user interface circuitry including the processor 202 may be configured to control one or more functions of one or more elements of the user interface through computer program instructions, for example, software and/or firmware, stored on a memory accessible to the processor 202. The user input interface may include devices allowing the UE 100 to receive data, such as a keypad 211, a touch display, a joystick, and/or at least one other input device. The keypad 211 may include numeric 0-9 and related keys, and/or other keys for operating the UE 100. The UE 100 may include a battery for powering various circuits related to the UE 100, for example, a circuit to provide mechanical vibration as a detectable output.

As shown in FIG. 2, the UE 100 may include memory, such as a subscriber identity module (SIM) 216, a removable user identity module (R-UIM), and/or the like, which may store information elements related to a mobile subscriber. In addition to the SIM 216, the UE 100 may include other removable and/or fixed computer-readable medium/memory. The computer-readable medium/memory may be implemented in the form of one or more memory devices, memory components, memory blocks, memory elements or other discrete gate or transistor logic or circuitry.

The UE 100 may include tangible storage such as a volatile memory 213 and/or a non-volatile memory 214 The non-volatile memory 214 may include read-only memory (ROM), solid state drive (SSD), a hard disk drive (HDD), or removable storage media. The volatile memory 213 may include Random Access Memory (RAM) including dynamic RAN (DRAM) and/or static RAM (SRAM), synchronous DRAM (SDRAM) such as low power double data rate (LPDDR) memory, on-chip cache memory, off-chip cache memory, and/or the like. The non-volatile memory 214, which may be embedded and/or removable, may include read-only memory, flash memory, magnetic storage devices such as hard disks, floppy disk drives, magnetic tape, optical disc drives and/or media, non-volatile random access memory (NVRAM), and/or the like. The volatile memory 213 and the non-volatile memory 214 may include a cache area for temporary storage of data. At least part of the volatile memory 213 and/or the non-volatile memory 214 may be embedded in the processor 202. The memories may store one or more software programs, instructions, pieces of information, data, and/or the like which may be used by the UE 100 for performing functions of the UE 100. The memories may include an identifier, such as an international mobile equipment identification (IMEI) code, capable of uniquely identifying the UE 100.

The UE 100 may include extended discontinuous reception (eDRX) cycles for power saving and relaxations for radio resource management (RRM) monitoring. The eDRX cycles may enable the UE 100 to remain in a low-power state for extended periods without having to wake up for monitoring network signals. The relaxations for RRM monitoring may reduce the frequency at which the UE 100 performs measurements on neighboring cells, thereby further reducing power consumption. In combination, the eDRX cycles and RRM monitoring relaxations may provide a substantial complexity reduction and an extended battery life for RedCap devices. Less traffic and signal requirements and not having to wake up the device while the device is in the eDRX cycles may further reduce the power consumption for the UE 100.

In order to receive downlink transmission, the UE 100 may include antennas that may receive the downlink signals from the network entity and may provide received signals to the demodulators (DEMODs) in transceivers, respectively. Each demodulator in transceivers may condition (e.g., filter, amplify, downconvert, and digitize) a respective received signal to obtain input samples. Each demodulator may further process the input samples to obtain received symbols. MIMO detector may obtain received symbols from all the demodulators in transceivers, perform MIMO detection on the received symbols if applicable, and provide detected symbols. Receive processor may process (e.g., demodulate, deinterleave, and decode) the detected symbols, provide decoded data for the UE 100 to a data sink, and provide decoded control information to a controller/processor.

In order to transmit uplink transmission, UE 100 further includes a transmit processor that may receive and process data (e.g., for the physical uplink shared channel (PUSCH)) from a data source and control information (e.g., for the physical uplink control channel (PUCCH)) from a controller/processor. Transmit processor may also generate reference symbols for a reference signal (e.g., for the SRS). The symbols from the transmit processor may be precoded by a TX MIMO processor if applicable, further processed by the modulators in transceivers (e.g., for SC-FDM), and transmitted to the network entity.

In some examples, the UE 100 may perform a channel coding operation or a FEC operation to control errors in transmitted information. For example, the UE 100 may perform an encoding operation to generate encoded information (such as by selectively introducing redundancy into the information, typically using an error correction code (ECC), such as a polar code or a low-density parity-check (LDPC) code). The UE 100 may further perform spatial processing (for example, precoding) on the encoded information to generate one or more processed or precoded signals for uplink transmission. In some examples, the UE 100 may perform codebook-based precoding or non-codebook-based precoding. Codebook-based precoding may involve selecting a precoder (for example, a precoding matrix) using a codebook. For example, the network entity may provide precoding information indicating which precoder, defined by the codebook, is to be used by the UE 100. Non-codebook-based precoding may involve selecting or deriving a precoder based on, or otherwise associated with, one or more downlink or uplink signal measurements. The UE 100 may transmit the processed uplink signals via one or more antennas.

As used herein, “transmitting” may refer to various mechanisms of outputting data, such as outputting data from data source, memory, transmit processor, controller/processor, TX MIMO processor, transceivers, antennas, and/or other aspects described herein. Similarly, “receiving” may refer to various mechanisms of obtaining data, such as obtaining data from antennas, transceivers, RX MIMO detector, controller/processor, receive processor, memory, and/or other aspects described herein.

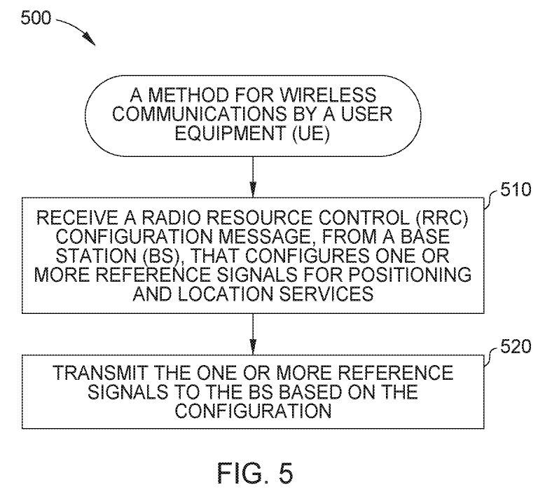

The processor 202 may be coupled to a computer-readable medium/memory via a bus. In certain aspects, the computer-readable medium/memory is configured to store instructions (e.g., computer-executable code) that when executed by the processor 202, cause the processor 202 to perform the method 500 described with respect to FIG. 5, or any aspect related to it. Note that reference to the processor 202 performing the method 500 may include one or more processors performing the method 500.

The computer-readable medium/memory stores code (e.g., executable instructions) for executing the method 500. For example, the computer-readable medium/memory stores code for receiving a RRC configuration message and/or code for transmitting one or more reference signals for positioning and location services.

The processor 202 may include circuitry configured to implement (e.g., execute) the code stored in the computer-readable medium/memory, including circuitry for receiving a RRC configuration message and/or circuitry for transmitting one or more reference signals for positioning and location services. Processing with the circuitry may cause the UE 100 to perform the method 500 described with respect to FIG. 5, or any aspect related to it.

### Example Base Station

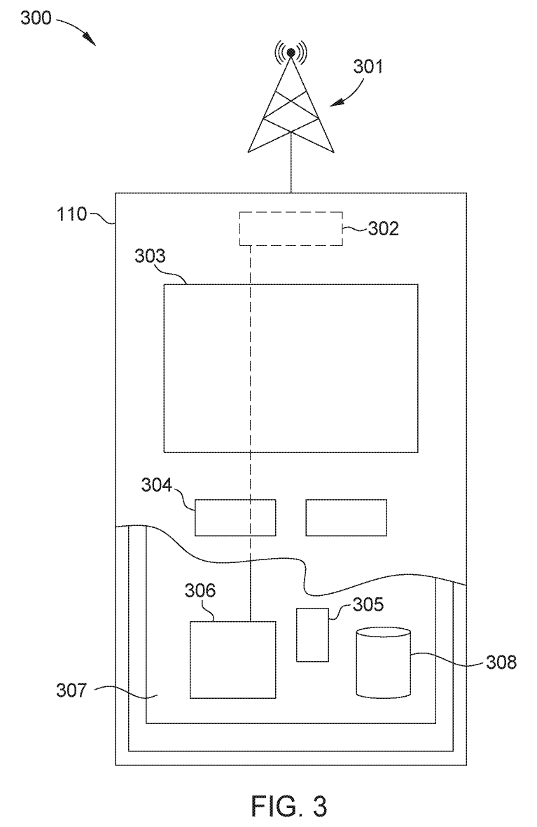

FIG. 3 depicts aspects of an example BS 110.

A BS 110 may provide communications coverage for a respective geographic coverage area, which may sometimes be referred to as a cell, and which may overlap in some cases. A BS 110 may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells. In a heterogeneous wireless communication network, different types of BSs support communication for one or more coverage areas using the same or different RATs.

A BS 110 may be implemented in an aggregated (such as monolithic, standalone) architecture, which may utilize a protocol stack that is physically or logically integrated within one BS 110 (such as a single physical RAN node). While BS 110 is depicted in various aspects as unitary communications devices, BS 110 may be implemented in various configurations. More generally, a BS 110 may include components that are located at a single physical location or components located at various physical locations. In examples in which a BS 110 includes components that are located at various physical locations, the various components may each perform functions such that, collectively, the various components achieve functionality that is similar to a BS that is located at a single physical location. For example, one or more components of a BS 110 may be disaggregated, which may utilize a protocol stack that is physically or logically distributed among multiple network entities, including in an integrated access and backhaul (IAB) network, an open RAN (O-RAN), or a virtualized RAN (vRAN). A disaggregated BS may include a central unit (CU), one or more distributed units (DUs), one or more radio units (RUs), a Near-Real Time (Near-RT) RAN Intelligent Controller (RIC), or a Non-Real Time (Non-RT) RIC, to name a few examples. In another example, various aspects of a BS 110 may be virtualized.

The BS 110 may include multiple processing entities 306 for different purposes, a memory 308, and other components 305 for use in software and hardware aided execution of tasks the BS 110 is designed to perform, including control and communications with other network entities, such as the AMF 107 and the LMF 103.

As shown in FIG. 3, the BS 110 may include a remote radio frequency (RF) unit 301 that handles RF processing functions. The remote RF unit 301 may be controlled and may communicate via an interface 302 and a processing unit 304. The interface 302 may facilitate communication between the remote RF unit 301 and internal processing elements of the BS 110. The processing unit 304 may be configured to control and communicate with the remote RF unit 301 via the interface 302.

With continued reference to FIG. 3, the BS 110 may include a control entity 303 that provides control functions to the overall BS 110 entity. The control entity 303 may be implemented to provide further functions to the BS 110. The processing entity 306 may be provided for different purposes within the BS 110, including processing of positioning information and management of SRS resources.

The processing, storage, and control apparatus of the BS 110 may be provided on an appropriate circuit board and/or in a chipset 307. The chipset 307 may contain integrated circuits and processing elements that support the various functions of the BS 110. The memory 308 may store data and program codes for the BS 110, including positioning information received from UEs and configuration parameters for SRS resources.

As further shown in FIG. 3, the components 305 may be used in software and hardware aided execution of tasks the BS 110 is designed to perform. The components 305 may support control and communications with other network entities.

The BS 110 may communicate with network entities such as the AMF 107 and the LMF 103, as well as with UEs within coverage of the BS 110.

The BS 110 may collect and store positioning information at all TRPs when SRS signals are received from UEs. The BS 110 may identify UE positions under coverage of the BS 110 based on the collected SRS information. When the LMF 103 requests location information, the BS 110 may provide the location information without having to contact the UE directly. The BS 110 may store the positioning information in the memory 308 for retrieval by the LMF 103. This approach may enable the network to obtain location information for RedCap devices and IoT devices without waking up the devices, thereby preserving battery life while maintaining positioning service capabilities.

The BS 110 may transmit data and/or control signaling. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications or downlink data channel communications. The control signaling may be for the physical broadcast channel (PBCH), physical control format indicator channel (PCFICH), physical HARQ indicator channel (PHICH), physical downlink control channel (PDCCH), group common PDCCH (GC PDCCH), and/or others. The data may be for the physical downlink shared channel (PDSCH), in some examples. Reference signals may include synchronization signal (PSS), secondary synchronization signal (SSS), PBCH demodulation reference signal (DMRS), channel state information reference signal (CSI-RS), phase tracking reference signal (PTRS), or tracking reference signal (TRS).

In order to receive uplink transmission, the BS 110 may include antennas that may receive the uplink signals from the UE 100 and may provide received signals to the DEMODs in transceivers, respectively. Each demodulator in transceivers may condition (e.g., filter, amplify, downconvert, and digitize) a respective received signal to obtain input samples. Each demodulator may further process the input samples to obtain received symbols. MIMO detector may obtain received symbols from all the demodulators in transceivers, perform MIMO detection on the received symbols if applicable, and provide detected symbols. Receive processor may process (e.g., demodulate, deinterleave, and decode) the detected symbols, provide decoded data for the BS 110 to a data sink, and provide decoded control information to a controller/processor.

In order to transmit downlink transmissions, BS 110 further includes a transmit processor that may receive and process data from a data source and control information from a controller/processor. Transmit processor may also generate reference symbols for a reference signal. The symbols from the transmit processor may be precoded by a TX MIMO processor if applicable, further processed by the modulators in transceivers (e.g., for SC-FDM), and transmitted to the UE 100.

In some examples, BS 110 may perform a channel coding operation or a FEC operation to control errors in transmitted information. For example, the BS 110 may perform an encoding operation to generate encoded information (such as by selectively introducing redundancy into the information, typically using an ECC, such as a polar code or a LDPC code. The BS 110 may further perform spatial processing (for example, precoding) on the encoded information to generate one or more processed or precoded signals for downlink transmission. In some examples, the BS 110 may perform codebook-based precoding or non-codebook-based precoding. Codebook-based precoding may involve selecting a precoder (for example, a precoding matrix) using a codebook. Non-codebook-based precoding may involve selecting or deriving a precoder based on, or otherwise associated with, one or more downlink or uplink signal measurements. The BS 110 may transmit the processed downlink signals via one or more antennas.

As used herein, “transmitting” may refer to various mechanisms of outputting data, such as outputting data from data source, memory, transmit processor, controller/processor, TX MIMO processor, transceivers, antennas, and/or other aspects described herein. Similarly, “receiving” may refer to various mechanisms of obtaining data, such as obtaining data from antennas, transceivers, RX MIMO detector, controller/processor, receive processor, memory, and/or other aspects described herein.

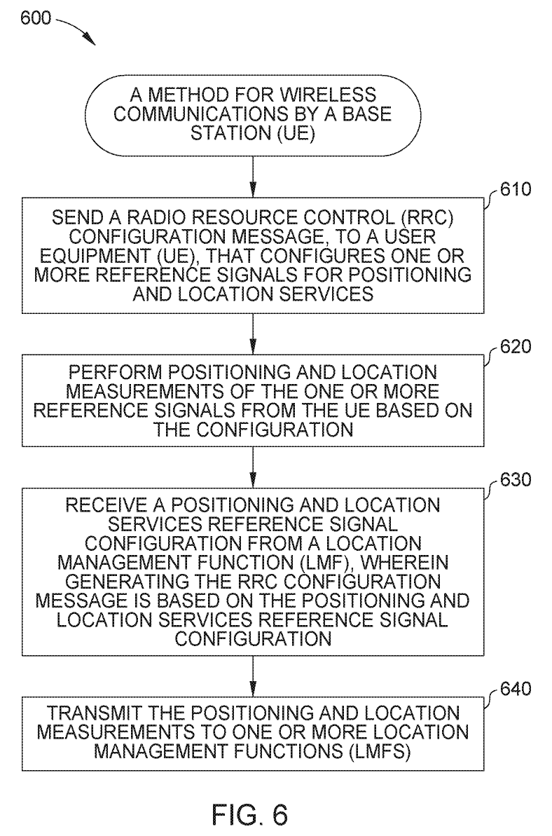

The processing unit 304 may be coupled to a computer-readable medium/memory via a bus. In certain aspects, the computer-readable medium/memory is configured to store instructions (e.g., computer-executable code) that when executed by the processing unit 304, cause the processing unit 304 to perform the method 600 described with respect to FIG. 6, or any aspect related to it. Note that reference to the processing unit 304 performing the method 600 may include one or more processors performing the method 600.

The computer-readable medium/memory stores code (e.g., executable instructions) for executing the method 600. For example, the computer-readable medium/memory stores code for sending a RRC configuration message, code for performing positioning and location measurements, code for receiving a positioning and location services reference signal configuration, and/or code for transmitting positioning and location measurements.

The processing unit 304 may include circuitry configured to implement (e.g., execute) the code stored in the computer-readable medium/memory, including circuitry for sending a RRC configuration message, circuitry for performing positioning and location measurements, circuitry for receiving a positioning and location services reference signal configuration, and/or circuitry for transmitting positioning and location measurements. Processing with the circuitry may cause the BS 110 to perform the method 600 described with respect to FIG. 6, or any aspect related to it.

### Aspects Related to Power Saving for Positioning and Location Services

3GPP 5G supports different positioning methods. Different positioning methods can use different reference signal measurements. A positioning and location service request may be initiated by a location service entity or by the UE 100. When the positioning and location service request is initiated, the LMF 103 may instigate positioning and location procedures with the UE 100 to obtain a location estimate or positioning measurements or to transfer location assistance data to the UE 100. In addition, the LMF 103 may instigate positioning and location procedures with the serving BS and may further instigate positioning and location procedures with one or more neighbouring BSs to obtain positioning measurements or assistance data.

RAT-dependent positioning technologies can use the cellular network radio signal to obtain the positioning measurements. These measurements can be based on the timing of the signal, such as DL-TDOA or Multi-RTT positioning and location services, based on the power of the signal (e.g. ECID), or based on the AoA/AoD of the signal. When the LMF 103 determines a positioning method for the UE 100, which requires positioning and location measurements by the BS 110, the LMF 103 can interact with the BS 110 to support the positioning and location service. In one or more aspects, the LMF 103 can request the BS 110 for an SRS configuration for the UE 100 and the BS 110 can respond with the SRS configuration to the LMF 103. The BS 110 can provide an updated SRS configuration to the LMF 103 when the SRS configuration changes.

In some aspects, if semi-persistent SRS or aperiodic SRS is configured at the UE 100, the LMF can activate or deactivate SRS. In some aspects, when the SRS is transmitted by the UE 100, the LMF 103 can request multiple BSs 110 or TRPs to perform uplink measurements of the SRS and to report the results to the LMF 103.

According to certain aspects, the BS 110 pre-configures the UE 100 in an RRC configuration message with a reference signal configuration for positioning and location reference signal transmission. In some aspects, the UE 100 may be in an RRC_CONNECTED mode or an RRC_INACTIVE mode during configuration and/or transmission of the positioning and location reference signal to support BS 110 measurements for a positioning and location service. The reference signal configuration for the positioning and location reference signal may provide a pre-configured measurement gap configuration(s) and pre-configured processing window for measurement. In some aspects, the UE TxTEG (Tx Timing Error Group) may be reported for UL-TDOA.

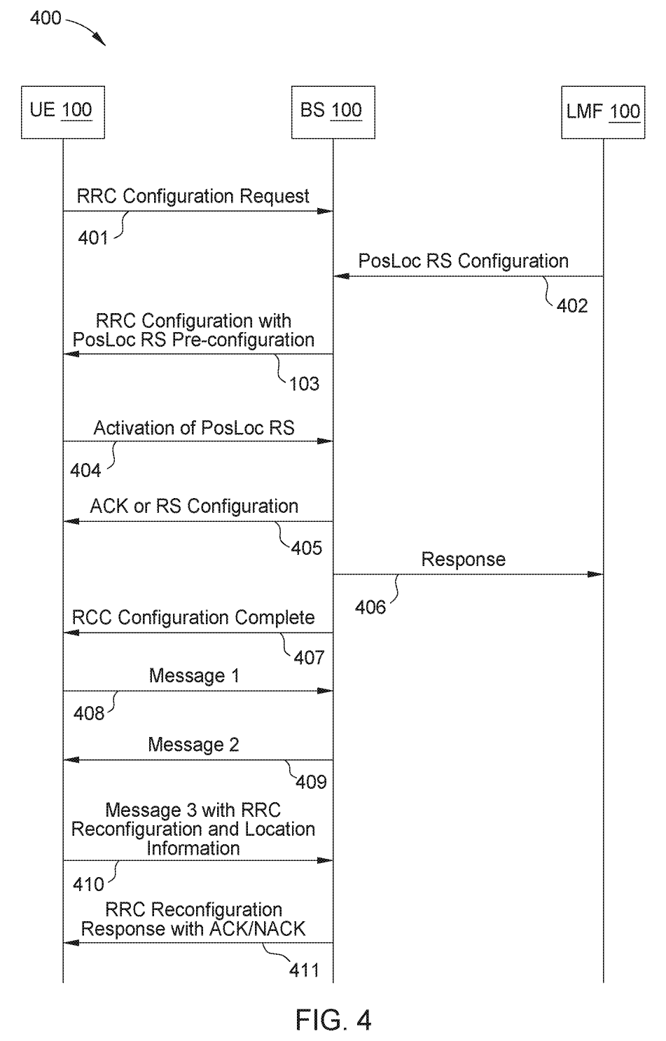

FIG. 4 depicts a call flow 400 diagram illustrating example operations for positioning and location services in a network between a UE 100, a BS 110, and an LMF 103.

The call flow enables preconfiguration of SRS resources for location events, which may reduce power consumption for RedCap devices and IoT devices by eliminating the need to wake up a device when a location information request is received.

The call flow may begin, at operation 401, with the UE 100 sending an RRC configuration request to the BS 110. The RRC configuration request, at operation 401, may initiate an attachment request from the UE 100 to the BS 110. The RRC configuration request, at operation 401, may establish initial communication between the UE 100 and the BS 110 for subsequent positioning configuration.

With continued reference to FIG. 4, at operation 402, the LMF 103 sends a reference signal for positioning and location (PosLoc) services configuration to the BS 110. The PosLoc RS configuration at operation 402 may configure SRS for positioning and location services. The PosLoc RS configuration at operation 402 may configure SRS events. The PosLoc RS configuration at operation 402 may include configuration parameters that the LMF 103 determines for the UE 100. In some aspects, the LMF 103 may request the BS 110 for an SRS configuration for the UE 100, and the BS 110 may respond with the requested UE SRS configuration to the LMF 103. The BS 110 may provide an updated SRS configuration to the LMF 103 when the SRS configuration changes. Although shown at the operation 401, the LMF 103 may send the PosLoc reference signal configuration to the BS 110 before the operation 401. The PosLoc RS configuration at operation 402 may indicate one or more cell IDs for SRS transmission, one or more scheduled times for SRS transmission, a periodicity for SRS transmission, and/or one or more events triggering SRS transmission for positioning and location services.

During initial attachment, at operation 403, the BS 110 may pre-configure PosLoc RS at the UE 100. The BS 110 may send, at the operation 403, an RRC_Reconfiguration message to the UE 100 pre-configuring the UE 100 for transmitting PosLoc RS. The RRC configuration at operation 403 may contain SRS pre-configuration resource set allocations for the UE 100. The BS 110 may configure the UE 100 with at least one of the SRS resource sets as periodic, aperiodic, or semi-persistent. The RRC configuration message at operation 403 may indicate one or more cell IDs for SRS transmission, one or more scheduled times for SRS transmission, a periodicity for SRS transmission, and/or one or more events triggering SRS transmission for positioning and location services. In some aspects, the RRC_Reconfiguration message contains a new IE preconfiguring the PosLoc RS for the UE 100. In some aspects, the IE is an srs-LocationEventRequest IE.

As further shown in FIG. 4, at operation 404, the UE 100 may send a PosLoc RS activation response to the BS 110. The PosLoc RS activation response at operation 404 may inform the BS 110 that configuration is successful. The PosLoc RS activation response at operation 404 may also request the BS 110 to allocate PosLoc RS resources as per configuration, as location transmission may start as per the defined resource sets. The UE 100 may activate the preconfigured PosLoc RS with a new cause code requesting the BS 110 to allocate resources accordingly.

At operation 405, the BS 110 sends an ACK to the UE 100 or configures SRS at the UE 100. In some aspects, at operation 405 the BS 110 sends an ACK to the UE 100 to acknowledge the SRS activation. In some aspects, at operation 405, the BS 110 may further configure SRS at the UE 100 if SRS is not previously configured. The SRS resource sets may be allocated when the BS 110 acknowledges the activation message from the UE 100.

With continued reference to FIG. 4, at operation 406, the BS 110 sends a response to the LMF 103. The response at operation 406 may include the SRS configuration that has been established with the UE 100. The LMF 103 may use the response to track the SRS configuration for the UE 100.

At operation 407, the UE 100 sends an RRC configuration complete message to the BS 110. The RRC configuration complete message at operation 407 may indicate that the UE 100 has completed the initial RRC configuration process. After the initial RRC configuration, SRS may be further configured with one or more triggering events.

As shown in FIG. 4, the call flow 400 continues, at operation 408, with a message 1 (Msg1) transmission from the UE 100 to the BS 110. The message1 transmission at operation 408 may be a random access channel (RACH) access probe from the UE 100. For example, the message 1 transmission at operation 408 may include a RACH preamble.

At operation 409, the BS 110 sends a message 2 (Msg2) transmission to the UE 100. The message 2 at operation 409 be a random access response (RAR) message from the BS 110 to establish an RRC_Connected state.

At operation 410, the UE 100 sends the BS 110 a message 3 (Msg3) transmission. The message 3 transmission at operation 410 may be a small data package. The small data package may consume little energy, providing power savings for RedCap devices and IoT devices. In some aspects, the message 3 transmission at operation 410 is a PUSCH transmission. In some aspects, the message 3 transmission at operation 410 includes an RRC reconfiguration request. In some aspects, the message 3 transmission at operation 410 includes location information.

With continued reference to FIG. 4, at operation 411, the BS 110 responds with an RRC reconfiguration response message to the UE 100. The RRC reconfiguration response at operation 411 may include an acknowledgment or negative acknowledgment. The RRC reconfiguration response at operation 411 may complete the positioning configuration process between the UE 100 and the BS 110. In some aspects, the srs-LocationEventRequest IE may be inserted into a modified RRC reconfiguration response message pre-configuring the UE 100 for transmitting PosLoc RS. The srs-LocationEventRequest IE at operation 411 may contain SRS pre-configuration resource set allocations for the UE 100. The srs-LocationEventRequest IE at operation 411 may configure the UE 100 with at least one of the SRS resource sets as periodic, aperiodic, or semi-persistent. The srs-LocationEventRequest IE at operation 411 may indicate one or more cell IDs for SRS transmission, one or more scheduled times for SRS transmission, a periodicity for SRS transmission, and/or one or more events triggering SRS transmission for positioning and location services.

The RRC protocol for NR may configure UEs with SRS for SRS transmission in RRC_CONNECTED and RRC_INACTIVE states to support base station measurements for NR positioning. The UE 100 may operate in RRC_CONNECTED and RRC_INACTIVE states for SRS transmission. The BS 110 may provide pre-configured measurement gap configurations and pre-configured positioning reference signal (PRS) processing windows for downlink PRS (DL-PRS) measurement. The UE 100 may report UE transmit timing error group (TxTEG) for uplink time difference of arrival (UL-TDOA) positioning.

The SRS for positioning may be configured with independent power control loops for different SRS instances. Since positioning involves measurements from multiple receiving base stations, the SRS may have enough range to reach not only the serving base station to which the UE 100 is connected, but also neighboring base stations involved in the positioning process. To minimize interference, the UE 100 may be configured with different SRS instances, each with independent power control loops. The independent power control loops may allow SRS pointed at neighbor cells to have better hearability while keeping interference low in the serving cell.

If semi-persistent or aperiodic SRS is configured to the UE 100, the LMF 103 may activate or deactivate the SRS. The LMF 103 may activate or deactivate semi-persistent or aperiodic SRS configured to the UE 100. When the SRS is transmitted by the UE 100, the LMF 103 may request multiple TRPs to perform uplink measurements and report results. The LMF 103 may request multiple TRPs to perform uplink measurements and report results when SRS is transmitted by the UE 100.

The srs-LocationEventRequest triggering event may contain one or more parameters including periodic SRS, scheduled time, affected cell ID, and periodicity. Periodic SRS may indicate the UE 100 to send SRS periodically without further instructions and/or requests from the LMF 103 or the base station 110. The UE 100 may send SRS by the scheduled time to the cells indicated by affected cell IDs with a time period equal to the periodicity parameter. The srs-LocationEventRequest triggering event may give the UE 100 freedom on controlling when and how often the UE 100 sends SRS if periodic SRS is set to 0 or a predefined parameter. This approach may provide various ways to activate SRS of the UE 100 while enabling power savings for RedCap devices and IoT devices.

After pre-configuration of the PosLoc RS, the UE 100 may transmit PosLoc RS according to the configuration. For example, the UE 100 may transmit the PosLoc RS periodically to the cell(s) indicated by affected cell ID(s) without further instructions and/or requests from LMF 103 or BS 110. The UE 100 may send the PosLoc RS at the scheduled times to the cell(s) indicated by affected cell ID(s). In some aspects, the PosLoc RS configuration may allow the UE 100 freedom on controlling when and how often the UE 100 sends the PosLoc, for example by setting periodic RS to 0 or some predefined parameter.

The BS 110, or multiple BSs 110 or TRP, can then monitor, according to the PosLoc RS configuration, and take positioning and location measurements of the PosLoc RS transmitted by the UE 100. The BS(s) 110 can then report the positioning and location measurements to one or more LMFs 103.

In some aspects, the NR-RAN, for example BS 110, can collect and store information at all TRPs or BSs 110 when PosLoc RS signals are received. The NR-RAN or BS 110 can identify UE 100 positions under its coverage with its collections. Thus, when the LMF 103 requests the location information, the NR-RAN and/or BS 110 can readily provide the UE location information without having to contact the UE directly by either the LMF 103 and/or the BS 110.

### Example Operations of a User Equipment

FIG. 5 depicts a method 500 for wireless communications by a UE, such as UE 100.

Method 500 begins at 510 with receiving a radio resource control (RRC) configuration message, from a base station (BS), that configures one or more reference signals for positioning and location services.

Method 500 then proceeds to step 520 with transmitting the one or more reference signals to the BS based on the configuration.

In one aspect, the RRC configuration message is a RRC reconfiguration message.

In one aspect, the one or more reference signals for positioning and location services comprises one or more sounding reference signal (SRSs).

In one aspect, the RRC configuration message includes a SRS request location event message element that requests the UE to transmit one or more SRS for the positioning and location services.

In one aspect, the SRS request location event message element configures one or more events triggering transmission of the one or more SRS for the positioning and location services, and transmitting the one or more reference signals to the BS is in response to occurrence of at least one of the configured one or more events.

In one aspect, the SRS request location event message element configures a periodicity for periodic transmission of the one or more SRS for the positioning and location services, and transmitting the one or more reference signals to the BS is at the configured periodicity.

In one aspect, the SRS request location event message element configures one or more scheduled times for the transmission of the one or more SRS for the positioning and location services, and transmitting the one or more reference signals to the BS is at the one or more scheduled times.

In one aspect, the SRS request location event message element indicates one or more cell identifiers (IDs) of one or more cells for the transmission of the one or more SRS for the positioning and location services, and transmitting the one or more reference signals to the BS is in the indicated one or more cells.

In one aspect, the RRC configuration message configures semi-persistent sounding reference signal (SRS) transmission.

In one aspect, the UE is a reduced capability (RedCap) UE.

Note that FIG. 5 is just one example of a method, and other methods including fewer, additional, or alternative steps are possible consistent with this disclosure.

### Example Operations of a Base Station

FIG. 6 depicts a method for wireless communications by a BS, such as BS 110.

Method 600 begins at 610 with sending a radio resource control (RRC) configuration message, to a user equipment (UE), that configures one or more reference signals for positioning and location services.

Method 600 then proceeds to step 620 with performing positioning and location measurements of the one or more reference signals from the UE based on the configuration.

In one aspect, the RRC configuration message is a RRC reconfiguration message.

In one aspect, the one or more reference signals for positioning and location services comprises one or more sounding reference signals (SRSs).

In one aspect, the RRC configuration message includes a SRS request location event message element that requests the UE to transmit one or more SRS for the positioning and location services.

In one aspect, the SRS request location event message element configures one or more events triggering transmission of the one or more SRS for the positioning and location services, and performing the positioning and location measurements of the one or more reference signals from the UE is in response to occurrence of at least one of the configured one or more events.

In one aspect, the SRS request location event message element configures a periodicity for periodic transmission of the one or more SRS for the positioning and location services, and performing the positioning and location measurements of the one or more reference signals from the UE is at the configured periodicity.

In one aspect, the SRS request location event message element configures one or more scheduled times for the transmission of the one or more SRS for the positioning and location services, and performing the positioning and location measurements of the one or more reference signals from the UE is at the one or more scheduled times.

In one aspect, the SRS request location event message element indicates one or more cell identifiers (IDs) of one or more cells for the transmission of the one or more SRS for the positioning and location services, and performing the positioning and location measurements of the one or more reference signals from the UE is in the indicated one or more cells.

In one aspect, method 600 further includes, at operation 630, receiving a positioning and location services reference signal configuration from a location management function (LMF), wherein generating the RRC configuration message is based on the positioning and location services reference signal configuration.

In one aspect, the positioning and location services reference signal configuration indicates at least one of: a periodicity, a cell identifier (ID), or one or more scheduled times for the transmission of the one or more SRS for the positioning and location services.

In one aspect, the RRC configuration message configures semi-persistent sounding reference signal (SRS) transmission.

In one aspect, method 600 further includes, at operation 640, transmitting the positioning and location measurements to one or more location management functions (LMFs).

Note that FIG. 6 is just one example of a method, and other methods including fewer, additional, or alternative steps are possible consistent with this disclosure.

### Example Operations of a Location Management Function

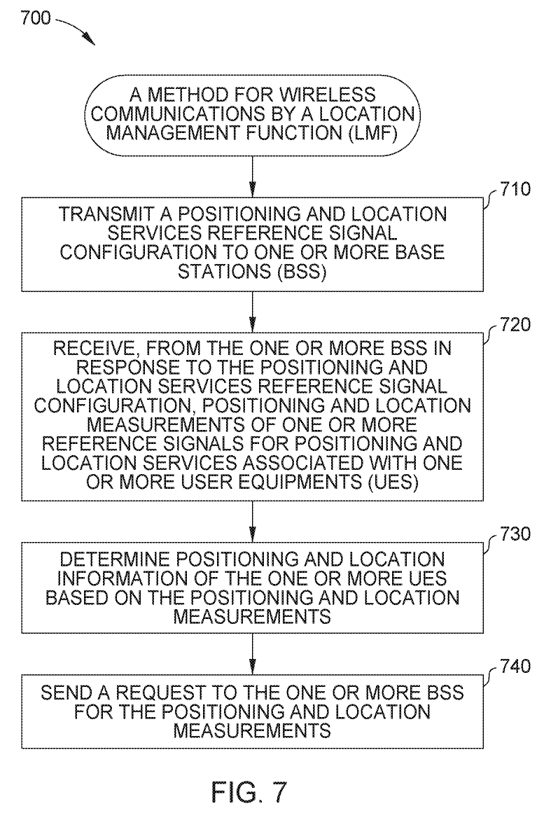

FIG. 7 depicts a method for wireless communications by a LMF, such as LMF 103.

Method 700 begins at 710 with transmitting a positioning and location services reference signal configuration to one or more base stations (BSs).

Method 700 then proceeds to step 720 with receiving, from the one or more BSs in response to the positioning and location services reference signal configuration, positioning and location measurements of one or more reference signals for positioning and location services associated with one or more user equipments (UEs).

Method 700 then proceeds to step 730 with determining positioning and location information of the one or more UEs based on the positioning and location measurements.

In one aspect, the positioning and location measurements includes positioning and location measurements of a UE from multiple BSs, and determining the positioning and location information of UE is based on the positioning and location measurements from the multiple BSs.

In one aspect, method 700 further includes sending a request to the one or more BSs for the positioning and location measurements.

In one aspect, the one or more reference signals for positioning and location services comprises one or more sounding reference signals (SRSs).

In one aspect, the positioning and location services reference signal configuration indicates one or more events for triggering transmission of the one or more SRS for the positioning and location services.

In one aspect, the positioning and location services reference signal configuration indicates a periodicity for periodic transmission of the one or more SRS for the positioning and location services.

In one aspect, the positioning and location services reference signal configuration indicates one or more scheduled times for the transmission of the one or more SRS for the positioning and location services.

In one aspect, the positioning and location services reference signal configuration indicates one or more cell identifiers (IDs) of one or more cells for the transmission of the one or more SRS for the positioning and location services.

Note that FIG. 7 is just one example of a method, and other methods including fewer, additional, or alternative steps are possible consistent with this disclosure.

### Example Clauses

Implementation examples are described in the following numbered clauses:

Clause 1: A method for wireless communications at a base station (BS), the method comprising: sending a radio resource control (RRC) configuration message, to a user equipment (UE), that configures one or more reference signals for positioning and location services; and performing positioning and location measurements of the one or more reference signals from the UE based on the configuration.

Clause 2: The method of Clause 1, wherein the RRC configuration message is a RRC reconfiguration message.

Clause 3: The method of any combination of Clauses 1-2, wherein the one or more reference signals for positioning and location services comprises one or more sounding reference signal (SRSs).

Clause 4: The method of Clause 3, wherein the RRC configuration message includes a SRS request location event message element that requests the UE to transmit one or more SRS for the positioning and location services.

Clause 5: The method of Clause 4, wherein: the SRS request location event message element configures one or more events triggering transmission of the one or more SRS for the positioning and location services; and performing the positioning and location measurements of the one or more reference signals from the UE is in response to occurrence of at least one of the configured one or more events.

Clause 6: The method of any combination of Clauses 4-5, wherein: the SRS request location event message element configures a periodicity for periodic transmission of the one or more SRS for the positioning and location services; and performing the positioning and location measurements of the one or more reference signals from the UE is at the configured periodicity.

Clause 7: The method of any combination of Clauses 4-6, wherein: the SRS request location event message element configures one or more scheduled times for the transmission of the one or more SRS for the positioning and location services; and performing the positioning and location measurements of the one or more reference signals from the UE is at the one or more scheduled times.

Clause 8: The method of any combination of Clauses 4-7, wherein: the SRS request location event message element indicates one or more cell identifiers (IDs) of one or more cells for the transmission of the one or more SRS for the positioning and location services; and performing the positioning and location measurements of the one or more reference signals from the UE is in the indicated one or more cells.

Clause 9: The method of any combination of Clauses 1-8, further comprising receiving a positioning and location services reference signal configuration from a location management function (LMF), wherein generating the RRC configuration message is based on the positioning and location services reference signal configuration.

Clause 10: The method of any combination of Clauses 9, wherein the positioning and location services reference signal configuration indicates at least one of: a periodicity, a cell identifier (ID), or one or more scheduled times for the transmission of the one or more SRS for the positioning and location services.

Clause 11: The method of any combination of Clauses 1-10, wherein the RRC configuration message configures semi-persistent sounding reference signal (SRS) transmission.

Clause 12: The method of any combination of Clauses 11, further comprising transmitting the positioning and location measurements to one or more location management functions (LMFs).

Clause 13: An apparatus, comprising: a memory comprising executable instructions; and one or more processors configured to execute the executable instructions and cause the apparatus to perform a method in accordance with any one of Clauses 1-12.

Clause 14: An apparatus, comprising means for performing a method in accordance with any one of Clauses 1-12.

Clause 15: A non-transitory computer-readable medium comprising executable instructions that, when executed by one or more processors of an apparatus, cause the apparatus to perform a method in accordance with any one of Clauses 1-12.

Clause 16: A computer program product embodied on a computer-readable storage medium comprising code for performing a method in accordance with any one of Clauses 1-12.

Clause 17: A method for wireless communications at a location management function (LMF), the method comprising: transmitting a positioning and location services reference signal configuration to one or more base stations (BSs); receiving, from the one or more BSs in response to the positioning and location services reference signal configuration, positioning and location measurements of one or more reference signals for positioning and location services associated with one or more user equipments (UEs); and determining positioning and location information of the one or more UEs based on the positioning and location measurements.

Clause 18: The method of Clause 17, wherein: the positioning and location measurements includes positioning and location measurements of a UE from multiple BSs; and determining the positioning and location information of UE is based on the positioning and location measurements from the multiple BSs.

Clause 19: The method of any combination of Clauses 17-18, further comprising sending a request to the one or more BSs for the positioning and location measurements.

Clause 20: The method of any combination of Clauses 17-19, wherein the one or more reference signals for positioning and location services comprises one or more sounding reference signals (SRSs).

Clause 21: The method of any combination of Clauses 20, wherein the positioning and location services reference signal configuration indicates one or more events for triggering transmission of the one or more SRS for the positioning and location services.

Clause 22: The method of any combination of Clauses 20-21, wherein the positioning and location services reference signal configuration indicates a periodicity for periodic transmission of the one or more SRS for the positioning and location services.

Clause 23: The method of any combination of Clauses 20-22, wherein the positioning and location services reference signal configuration indicates one or more scheduled times for the transmission of the one or more SRS for the positioning and location services.

Clause 24: The method of any combination of Clauses 20-23, wherein the positioning and location services reference signal configuration indicates one or more cell identifiers (IDs) of one or more cells for the transmission of the one or more SRS for the positioning and location services.

Clause 25: An apparatus, comprising: a memory comprising executable instructions; and one or more processors configured to execute the executable instructions and cause the apparatus to perform a method in accordance with any one of Clauses 17-24.

Clause 26: An apparatus, comprising means for performing a method in accordance with any one of Clauses 17-24.

Clause 27: A non-transitory computer-readable medium comprising executable instructions that, when executed by one or more processors of an apparatus, cause the apparatus to perform a method in accordance with any one of Clauses 17-24.

Clause 28: A computer program product embodied on a computer-readable storage medium comprising code for performing a method in accordance with any one of Clauses 17-24.

Clause 29: A method for wireless communications at a user equipment (UE), the method comprising: receiving a radio resource control (RRC) configuration message, from a base station (BS), that configures one or more reference signals for positioning and location services; and transmitting the one or more reference signals to the BS based on the configuration.

Clause 30: The method of Clause 29, wherein the RRC configuration message is a RRC reconfiguration message.

Clause 31: The method of any combination of Clauses 29-30, wherein the one or more reference signals for positioning and location services comprises one or more sounding reference signal (SRSs).

Clause 32: The method of any combination of Clauses 31, wherein the RRC configuration message includes a SRS request location event message element that requests the UE to transmit one or more SRS for the positioning and location services.

Clause 33: The method of any combination of Clauses 32, wherein: the SRS request location event message element configures one or more events triggering transmission of the one or more SRS for the positioning and location services; and transmitting the one or more reference signals to the BS is in response to occurrence of at least one of the configured one or more events.

Clause 34: The method of any combination of Clauses 32-33, wherein: the SRS request location event message element configures a periodicity for periodic transmission of the one or more SRS for the positioning and location services; and transmitting the one or more reference signals to the BS is at the configured periodicity.

Clause 35: The method of any combination of Clauses 32-34, wherein: the SRS request location event message element configures one or more scheduled times for the transmission of the one or more SRS for the positioning and location services; and transmitting the one or more reference signals to the BS is at the one or more scheduled times.

Clause 36: The method of any combination of Clauses 32-35, wherein: the SRS request location event message element indicates one or more cell identifiers (IDs) of one or more cells for the transmission of the one or more SRS for the positioning and location services; and transmitting the one or more reference signals to the BS is in the indicated one or more cells.

Clause 37: The method of any combination of Clauses 29-36, wherein the RRC configuration message configures semi-persistent sounding reference signal (SRS) transmission.

Clause 38: The method of any combination of Clauses 29-37, wherein the UE is a reduced capability (RedCap) UE.

Clause 39: An apparatus, comprising: a memory comprising executable instructions; and one or more processors configured to execute the executable instructions and cause the apparatus to perform a method in accordance with any one of Clauses 29-38.

Clause 40: An apparatus, comprising means for performing a method in accordance with any one of Clauses 29-38.

Clause 41: A non-transitory computer-readable medium comprising executable instructions that, when executed by one or more processors of an apparatus, cause the apparatus to perform a method in accordance with any one of Clauses 29-38.

Clause 42: A computer program product embodied on a computer-readable storage medium comprising code for performing a method in accordance with any one of Clauses 29-38.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

Although aspects of 5G or 6G systems may be described for purposes of example and corresponding terminology may be used in the description, the techniques described herein are applicable beyond 5G, or 6G networks. For example, the described techniques may be applicable to other communication systems such as IEEE 802.11 (Wi-Fi, IEEE 802.20, Flash-OFDM, or other systems and radio technologies not explicitly mentioned herein.

The various illustrative logical blocks, modules and circuits described in connection with the present disclosure may be implemented or performed with a general purpose processor, a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration. Further, a processor may be an application processor, host processor, processing units (such as central processing units (CPUs), graphics processing units (GPUs), neural processing units (NPUs) (also referred to as neural network processors or deep learning processors (DLPs)), data processing units (DPUs), associative processing units (APUs), tensor processing units (TPUs), language processing units (LPU), vision processing units (VPUs), quantum processing units (QPUs), processing blocks, or other discrete gate or transistor logic or circuitry (each of which may be generally referred to herein individually as “a processor” or “processor circuitry).

As used herein, “a processor,” “at least one processor” or “one or more processors” generally refers to a single processor configured to perform one or multiple operations or multiple processors configured to collectively perform one or more operations. In the case of multiple processors, performance of the one or more operations could be divided amongst different processors, though one processor may perform multiple operations, and multiple processors could collectively perform a single operation. A group of processors collectively configurable or configured to perform a set of operations may include a first processor configurable or configured to perform a first operation of the set and a second processor configurable or configured to perform a second, different operation of the set. In some other examples, each of a group of processors may be configurable or configured to perform a same set of operations. Similarly, “a memory,” “at least one memory” or “one or more memories” generally refers to a single memory configured to store data and/or instructions, multiple memories configured to collectively store data and/or instructions.

As described herein, being “configured to,” being “configurable to,” and being “operable to” may be used interchangeably and may be associated with a capability, when executing code (such as processor-executable code, instructions) stored in memory circuitry (such as a non-transitory computer-readable medium, of the memory circuitry, storing code for wireless communication that is executable by a processing system) or otherwise, to perform one or more of the functions described herein.

In some cases, rather than actually transmitting a signal, an apparatus (e.g., a wireless node or device) may have an interface to output the signal for transmission. For example, a processor may output a signal, via a bus interface, to a radio frequency (RF) front end for transmission. Accordingly, a means for outputting may include such an interface as an alternative (or in addition) to a transmitter or transceiver. Similarly, rather than actually receiving a signal, an apparatus (e.g., a wireless node or device) may have an interface to obtain a signal from another device. For example, a processor may obtain (or receive) a signal, via a bus interface, from an RF front end for reception. Accordingly, a means for obtaining may include such an interface as an alternative (or in addition) to a receiver or transceiver.

While the present disclosure may describe certain operations as being performed by one type of wireless node, the same or similar operations may also be performed by another type of wireless node. For example, operations performed by a UE may also (or instead) be performed by a network entity (e.g., a BS or unit of a disaggregated BS ). Similarly, operations performed by a network entity may also (or instead) be performed by a UE.

Further, while the present disclosure may describe certain types of communications between different types of wireless nodes (e.g., between a network entity and a UE), the same or similar types of communications may occur between same types of wireless nodes (e.g., between network entities or between UEs, in a peer-to-peer scenario). Further, communications may occur in reverse order than described.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c). Additionally, as used herein, a phrase referring to “a” or “an” element refers to one or more of such elements acting individually or collectively to perform the recited function(s). Thus, the terms “a,” “at least one,” “one or more,” and “at least one of one or more” may be interchangeable. For instance, for a claim that refers to “a” component performing one or more functions, each of the individual functions may be performed by a single component or by any combination of multiple components, and subsequent reference to a component introduced with the article “a” using the term “the” may refer to any or all of the single or multiple components. Thus, a component introduced with the article “a” may be understood to mean “one or more” components, and referring to “the” component subsequently in the claims may be understood to be equivalent to referring to “at least one of the one or more” components. Additionally, as used herein, a “set” can refer to one or more items, and a “subset” can refer to a whole set or less than the whole set, but not an empty set. Additionally, as used herein, the term “or” is intended to be interpreted in the inclusive sense, such as when referring to a series, and may be used interchangeably with the term “and/or,” unless otherwise explicitly indicated (for example, if used in conjunction with “either” or “only one of”). For example, “a or b” may include a only, b only, or a combination of a and b. Also, as used herein, the terms “has,” “have,” “having,”

“comprise,” “comprising,” “include” and “including,” and derivatives thereof or similar terms are intended to be open-ended terms that do not limit an element that they modify (for example, an element “having” a also may have b).

As used herein, the term “determine” or “determining” encompasses one or more of a variety of actions. For example, “determining” can include one or more of calculating, computing, processing, deriving, detecting, estimating, investigating, looking up, inferring, ascertaining, measuring, resolving, selecting, obtaining, choosing, identifying, interpreting, demodulating, decoding, reading, establishing, forming, or generating, among other examples. In some examples, determining can involve a processing system performing some type of calculating, computing, deriving, estimating, inferring, ascertaining, resolving, predicting, or other processing to obtain one or more numerical values, sets, elements, or other information or results. In some examples, determining can involve a processing system identifying, looking up, investigating, or otherwise obtaining some type of value, set, element, or other information or result from a table, data structure, database, or an implementation of memory, such as from a larger set of values, sets, or elements or other information or results. In some examples, determining can involve a processing system identifying, interpreting, demodulating, decoding, detecting, reading, or otherwise obtaining some type of value, set, element, or other information or result signaled in, for example, a received wireless signal. In some examples, determining can involve a processing system performing a measurement, such as on a received signal.

As used herein, the phrase “based on” is equivalent to “based at least in part on” and indicates a non-limiting relationship between elements “a” and “b.” In some aspects, a’ (which may be a variation or example of a) may be responsive to or in response to b’ (which may be a variation or example of b), such as if condition c is met. In some other aspects, a’’ (which may be a variation or example of at least one of a or a’) may be associated with b’’ (which may be a variation or example of at least one of b or b’). In some further aspects, a’’’ (which may be a variation or example of at least one of a or a’ or a’’) may be determined (or any of the other actions encompassed by usage of the word “determining” as described above) in accordance with b’’’ (which may be a variation or example of at least one of b or b’ or b’’). Furthermore, what follows the phrase “in accordance with,” “as a function of,” “in response to,” “responsive to,” or “using” is not necessarily the focal point or primary factor associated with the limitation preceding the phrase. For example, the phrases “in accordance with,” “based on,” “based at least in part on,” “as a function of,” “in response to,” “responsive to,” “associated with,” or “using” are not to be construed as a reference to a closed set of conditions, factors, criteria, elements, components or actions, among other examples.

As used herein, “satisfying a threshold” may, depending on the context, refer to a value being greater than the threshold, greater than or equal to the threshold, less than the threshold, less than or equal to the threshold, equal to the threshold, or not equal to the threshold.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. §112(f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method for wireless communications at a base station (BS), the method comprising:
sending a radio resource control (RRC) configuration message, to a user equipment (UE), that configures one or more reference signals for positioning and location services; and
performing positioning and location measurements of the one or more reference signals from the UE based on the configuration.

2. The method of claim 1, wherein the RRC configuration message is a RRC reconfiguration message.

3. The method of claim 1, wherein the one or more reference signals for positioning and location services comprises one or more sounding reference signal (SRSs).

4. The method of claim 3, wherein the RRC configuration message includes a SRS request location event message element that requests the UE to transmit one or more SRS for the positioning and location services.

5. The method of claim 4, wherein:
the SRS request location event message element configures one or more events triggering transmission of the one or more SRS for the positioning and location services; and
performing the positioning and location measurements of the one or more reference signals from the UE is in response to occurrence of at least one of the configured one or more events.

6. The method of claim 4, wherein:
the SRS request location event message element configures a periodicity for periodic transmission of the one or more SRS for the positioning and location services; and
performing the positioning and location measurements of the one or more reference signals from the UE is at the configured periodicity.

7. The method of claim 4, wherein:
the SRS request location event message element configures one or more scheduled times for the transmission of the one or more SRS for the positioning and location services; and
performing the positioning and location measurements of the one or more reference signals from the UE is at the one or more scheduled times.

8. The method of claim 4, wherein:
the SRS request location event message element indicates one or more cell identifiers (IDs) of one or more cells for the transmission of the one or more SRS for the positioning and location services; and
performing the positioning and location measurements of the one or more reference signals from the UE is in the indicated one or more cells.

9. The method of claim 1, further comprising receiving a positioning and location services reference signal configuration from a location management function (LMF), wherein generating the RRC configuration message is based on the positioning and location services reference signal configuration.

10. The method of claim 9, wherein the positioning and location services reference signal configuration indicates at least one of: a periodicity, a cell identifier (ID), or one or more scheduled times for the transmission of the one or more SRS for the positioning and location services.

11. The method of claim 1, wherein the RRC configuration message configures semi-persistent sounding reference signal (SRS) transmission.

12. The method of claim 11, further comprising transmitting the positioning and location measurements to one or more location management functions (LMFs).

13. A method for wireless communications at a location management function (LMF), the method comprising:
transmitting a positioning and location services reference signal configuration to one or more base stations (BSs);
receiving, from the one or more BSs in response to the positioning and location services reference signal configuration, positioning and location measurements of one or more reference signals for positioning and location services associated with one or more user equipments (UEs); and
determining positioning and location information of the one or more UEs based on the positioning and location measurements.

14. The method of claim 13, wherein:
the positioning and location measurements includes positioning and location measurements of a UE from multiple BSs; and
determining the positioning and location information of UE is based on the positioning and location measurements from the multiple BSs.

15. The method of claim 13, further comprising sending a request to the one or more BSs for the positioning and location measurements.

16. The method of claim 13, wherein the one or more reference signals for positioning and location services comprises one or more sounding reference signals (SRSs).

17. The method of claim 16, wherein the positioning and location services reference signal configuration indicates one or more events for triggering transmission of the one or more SRS for the positioning and location services.

18. The method of claim 16, wherein the positioning and location services reference signal configuration indicates a periodicity for periodic transmission of the one or more SRS for the positioning and location services.

19. The method of claim 16, wherein the positioning and location services reference signal configuration indicates one or more scheduled times for the transmission of the one or more SRS for the positioning and location services.

20. The method of claim 16, wherein the positioning and location services reference signal configuration indicates one or more cell identifiers (IDs) of one or more cells for the transmission of the one or more SRS for the positioning and location services.

21. A method for wireless communications at a user equipment (UE), the method comprising:
receiving a radio resource control (RRC) configuration message, from a base station (BS), that configures one or more reference signals for positioning and location services; and
transmitting the one or more reference signals to the BS based on the configuration.

22. The method of claim 21, wherein the RRC configuration message is a RRC reconfiguration message.

23. The method of claim 21, wherein the one or more reference signals for positioning and location services comprises one or more sounding reference signal (SRSs).

24. The method of claim 23, wherein the RRC configuration message includes a SRS request location event message element that requests the UE to transmit one or more SRS for the positioning and location services.

25. The method of claim 24, wherein:
the SRS request location event message element configures one or more events triggering transmission of the one or more SRS for the positioning and location services; and
transmitting the one or more reference signals to the BS is in response to occurrence of at least one of the configured one or more events.

26. The method of claim 24, wherein:
the SRS request location event message element configures a periodicity for periodic transmission of the one or more SRS for the positioning and location services; and
transmitting the one or more reference signals to the BS is at the configured periodicity.

27. The method of claim 24, wherein:
the SRS request location event message element configures one or more scheduled times for the transmission of the one or more SRS for the positioning and location services; and
transmitting the one or more reference signals to the BS is at the one or more scheduled times.

28. The method of claim 24, wherein:
the SRS request location event message element indicates one or more cell identifiers (IDs) of one or more cells for the transmission of the one or more SRS for the positioning and location services; and
transmitting the one or more reference signals to the BS is in the indicated one or more cells.

29. The method of claim 21, wherein the RRC configuration message configures semi-persistent sounding reference signal (SRS) transmission.

30. The method of claim 21, wherein the UE is a reduced capability (RedCap) UE.
